(19) United States
(12) Patent Application Publication
(10) Pub. No.: US 2009/0198372 A1
(43) Pub. Date: Aug. 6, 2009

(54) BATTERY CHARGING AND TRANSFER SYSTEM FOR ELECTRICALLY POWERED VEHICLES

(75) Inventor: Julius G. Hammerslag, La Quinta, CA (US)

Correspondence Address: KNOBBE MARTENS OLSON & BEAR LLP, 2040 MAIN STREET, FOURTEENTH FLOOR, IRVINE, CA, 92614, US

(73) Assignee: Unlimited Range Electric Car Systems Company, La Quinta, CA (US)

(21) Appl. No.: 12/333,245

(22) Filed: Dec. 11, 2008

Related U.S. Application Data
(60) Provisional application No. 61/026,448, filed on Feb. 5, 2008.

(51) Int. Cl. G06F 7/00; G05B 19/00; G08B 21/00; B60Q 1/00

(52) U.S. Cl. 700/226; 700/230; 700/225; 340/636.1; 340/455; 700/228

(57) ABSTRACT

A battery transfer and charging system for electric vehicles is described. A station removes one or more spent batteries of electric vehicles having multiple batteries. The receiving system includes an engagement device for engaging with engagement structures of the batteries, in order to assist the removal of spent batteries. Spent batteries removed from vehicles may be tested and charged as they progress through the system in an assembly-line fashion. Following recharge, batteries may be transferred to the displacement station for installation within later vehicles. Batteries which cannot adequately be recharged can be automatically removed from the system.

### CROSS-REFERENCE TO RELATED APPLICATIONS

The present application claims priority under 35 U.S.C. §119(e) to U.S. Provisional Application No. 61/026,448 filed on Feb. 05, 2008, the disclosure of which is incorporated by reference herein in its entirety.

### FIELD OF THE INVENTION

This invention relates to battery charging and transfer systems, more particularly to such systems which enable the automated exchange and charging of batteries for electric vehicles, including wherein such vehicles carry a plurality of batteries.

### BACKGROUND OF THE INVENTION

As the cost of fossil fuel rises and there are increasing concerns about emission of greenhouse gases from motorized vehicles which burn such fossil fuels, there is an increased need for vehicles which use alternative types of energy. Electric automobiles have long been known as one such alternative, which have a very significant cost advantage per mile driven over vehicles which burn fossil fuels. Typically, the fuel cost per mile driven for electric automobiles is about two cents, as opposed to more than twenty cents for vehicles which burn fossil fuels. However, electric automobiles were not widely accepted by the public, in part because of the limited driving range of such vehicles before recharging is needed. As gas/electric hybrid vehicles gain more public acceptance and there is a greater demand for fully electric vehicles, there is a need for a system that provides, for a fully electric vehicle, the same kind of unlimited driving range enjoyed by gas or gas/electric hybrids by virtue of their ability to refuel.

In order to provide a practical electric vehicle system, battery transfer capabilities must exist at numerous locations, so that the range of travel, without requiring the driver to recharge a battery, may be substantial. This is to say that if the range of an electric vehicle, without recharge of the battery or battery pack is 100 miles, then the user is limited to excursions of 50 miles. However, if at 75 or 100 mile intervals, the user can conveniently replace the partially spent battery with a fresh or fully charged battery, the limit of safe travel is extended.

### SUMMARY OF THE INVENTION

In accordance with one embodiment there is provided a battery management system comprising a battery control system, a battery transfer station and an electric vehicle with a system for powering the vehicle. The system for powering the vehicle may comprise a battery array with at least two individual batteries and an electric motor wherein the battery control system comprises an element to communicate with the battery transfer station.

In some embodiments, the battery transfer station may comprise a drive through vehicle bay and a continuous battery transfer conveyor within the transfer station. The conveyor may have a battery receiving end which receives an at least partially discharged battery from a first end of the battery compartment. The conveyor may also have a battery delivery end which delivers a charged battery to a second end of the battery compartment, as well as multiple battery positions between the receiving and delivery ends to hold multiple batteries. In some embodiments, a computer controls the battery transfer conveyor by positioning the electric vehicle so that the battery receiving and delivery ends are adjacent the individual discharged batteries and also advances the conveyor in single-battery-position increments to move batteries from the battery receiving end to the battery delivery end. Some embodiments may also include a communication element to transmit and receive information with the battery control system.

Certain embodiments also provide a method of rapidly exchanging a battery of an electrically powered vehicle that may have at least two batteries within a compartment which extends through at least a portion of the vehicle. In some embodiments, the method provides a battery transfer station, as described previously. The method may further comprise communicating wirelessly or wired with the battery transfer system to receive the history and current charge level information for each separate battery. In some embodiments, the method comprises positioning the vehicle within the battery transfer station such that the first discharged battery is aligned with the battery receiving and delivery ends of the conveyor. Also, the method may comprise receiving payment source information via a payment system to enable the computer to initiate a battery exchange operation. The method may also comprise exchanging a first discharged battery with a first charged battery by programmably advancing the conveyor with the computer to shift the first charged battery from the delivery end of the conveyor into the compartment and moving the first discharged battery from the compartment to the receiving end of the conveyor.

### BRIEF DESCRIPTION OF THE DRAWINGS

FIG. 1 is a top plan view, with parts broken away, showing a battery transfer and charging system in accordance with one embodiment.

FIG. 2 is a vertical sectional view on the line 2-2 of FIG. 1, showing a first module in full lines, and showing additional modules in broken lines, according to one embodiment.

FIG. 3 is a transverse sectional view on the line 3-3 of FIG. 1.

FIG. 4 illustrates the primary computer-based components of a system, according to one embodiment.

FIG. 5A is a block diagram showing a preferred database implementation in which battery history data is maintained in a centralized computer database.

FIG. 5B illustrates a process followed by the computer of FIG. 5A when a battery is initially extracted from a vehicle.

FIG. 6 is a predominantly bottom perspective view of an an example of a battery or battery box.

FIG. 7 is a transverse, fragmentary sectional view on the line 7-7 of FIG. 2.

FIG. 8 is an enlarged, fragmentary top plan view, on the line 8-8 of FIG. 3, with parts broken away, showing the battery installation means.

FIG. 9 is a vertical sectional view on the line 9-9 of FIG. 8, with parts broken away.

FIG. 10 is a perspective view illustrating the general manner by which expansion conveyors are added to the system in one embodiment.

FIG. 11 is a transverse sectional view taken along the line 11-11 in FIG. 10.

FIG. 12 is an isometric view illustrating a motorscooter battery transfer and charging system in accordance with one embodiment.

FIG. 13 is a top plan view of the battery transfer and charging system of FIG. 12, illustrating additional details of the system.

FIG. 14 is an enlarged top plan view illustrating one embodiment of a motorscooter support mechanism in accordance with one embodiment.

FIG. 15 is a vertical sectional view taken along the line 15-15 of FIG. 12.

FIG. 16 is a transverse sectional view taken along the line 16-16 in FIG. 14, illustrating a vertically oriented embodiment of the battery transfer and charging system in accordance with one embodiment.

FIG. 17 is a predominantly bottom perspective view of an alternative example of a battery.

FIG. 18 illustrates one embodiment of a car-type four wheeled vehicle having four batteries placed in an arrangement transverse to the longitudinal axis of the vehicle.

FIG. 19 illustrates one embodiment of a scooter-type two wheeled vehicle having four batteries placed in an arrangement transverse to the longitudinal axis of the vehicle.

FIG. 20 illustrates one embodiment of a battery control system having wireless communication capabilities and a dashboard gauge to communicate charge status to the driver.

FIG. 21 illustrates one embodiment of a battery exchange station using a loop-type closed supply arrangement.

FIG. 22 illustrates one embodiment of a battery exchange station for scooter-type vehicles.

FIG. 23 illustrates a flowchart for one embodiment of a method of exchanging one or more batteries in an automobile or a scooter-type vehicle.

### DETAILED DESCRIPTION OF THE PREFERRED EMBODIMENTS

U.S. Pat. Nos. 5,549,443; 5,711,648; and 5,927,938 disclose electric battery charging and transfer systems which enable the efficient and convenient removal of discharged batteries from an electric vehicle and replacement with a fully charged battery. An electric vehicle is placed in a predetermined location of the electric battery charging and transfer system. The system mechanically removes the spent battery and replaces it with a fully charged battery quickly and efficiently to minimize the time spent at the battery transfer station. The spent battery is tested for reusability and, if suitable for reuse, placed in a charging system that recharges the battery for reuse in another electric vehicle. The batteries not suitable for reuse are separately stored for repair or replacement.

Thus, the prior patent discloses an invention which enables longer range use of electric vehicles, because charged or fresh batteries can be expeditiously installed in the vehicle at locations along a course of a length greater than the round trip capability of the vehicle battery. With such a system, vehicles can be sold with an initial composite of multiple batteries where each individual battery can be exchanged for a fresh battery at a battery transfer station for a relatively small cost, amounting to the re-charging cost of the battery, plus depreciation and exchange, by a battery charging organization having stations located strategically in areas to service a growing population of compatible electric vehicles.

Notwithstanding the foregoing, there remains a need for systems that allow replenishing the electric charge in vehicles without wasting the charge remaining in the previous battery. When servicing a vehicle with a single battery, the used battery normally still holds some amount of charge.

Disclosed herein are battery management systems for quick and efficient battery exchanges for vehicles comprising at least two separable batteries. The system comprises a battery control system in an electric vehicle, which works in conjunction with battery transfer stations located at one or more strategic locations throughout an area to quickly exchange depleted batteries to extend the travel range of electric vehicles and circumvent certain limitations of some electric vehicles. The vehicles which utilize the battery management systems can be of any type, including, but not limited to, land vehicles such as passenger cars, SUVs, vans, trucks (light duty, heavy duty, passenger, cargo) motorcycles, scooters, ATVs, and snowmobiles.

Preferred embodiments may include at least one of several improvements upon the earlier U.S. Pat. Nos. 5,549,443; 5,711,648; and 5,927,938. One improvement is the inclusion of a battery control system, which monitors the status of the batteries. Some possible functions of the battery control system are selecting which battery to use, updating a status gauge that can be monitored by the driver, providing an alert when battery power runs low, and directing the energy stored by the battery to a motor. The battery control system can also communicate with the transfer station by a wireless or wired connection to provide information, such as which batteries are depleted or defective. Also, the communication can include payment information for quick and automated battery exchange.

Another improvement over the earlier patents listed above includes multiple batteries. Replacement of a single battery with two or more smaller batteries can provide advantages, including reduced cost per battery and/or the ability to use all the energy of the battery by fully discharging the battery prior to recharging and replacing, which can have significant positive effects on battery life.

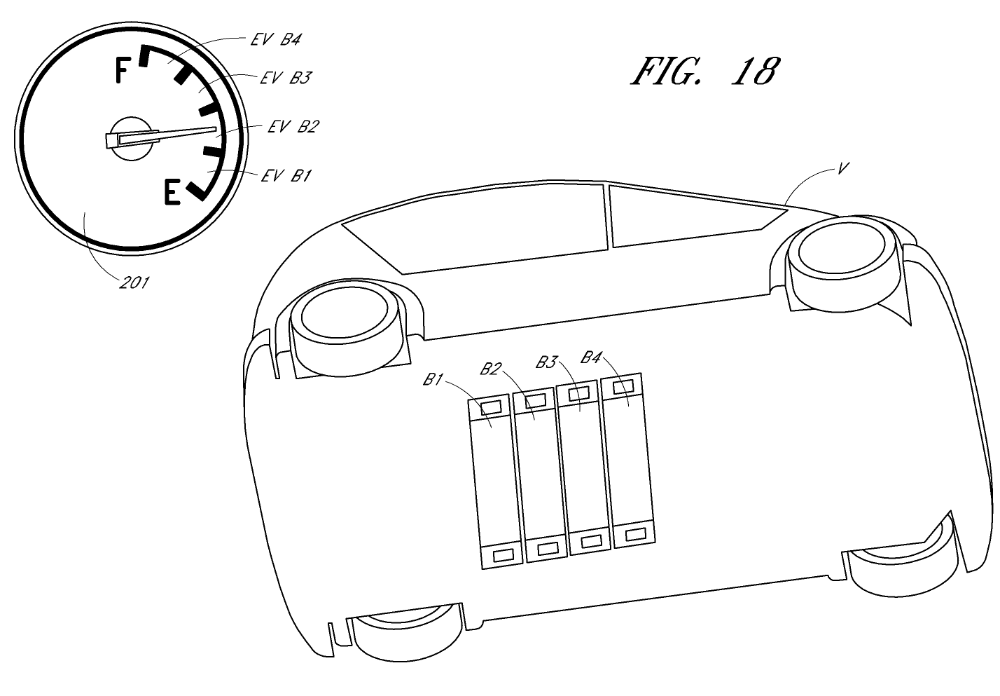

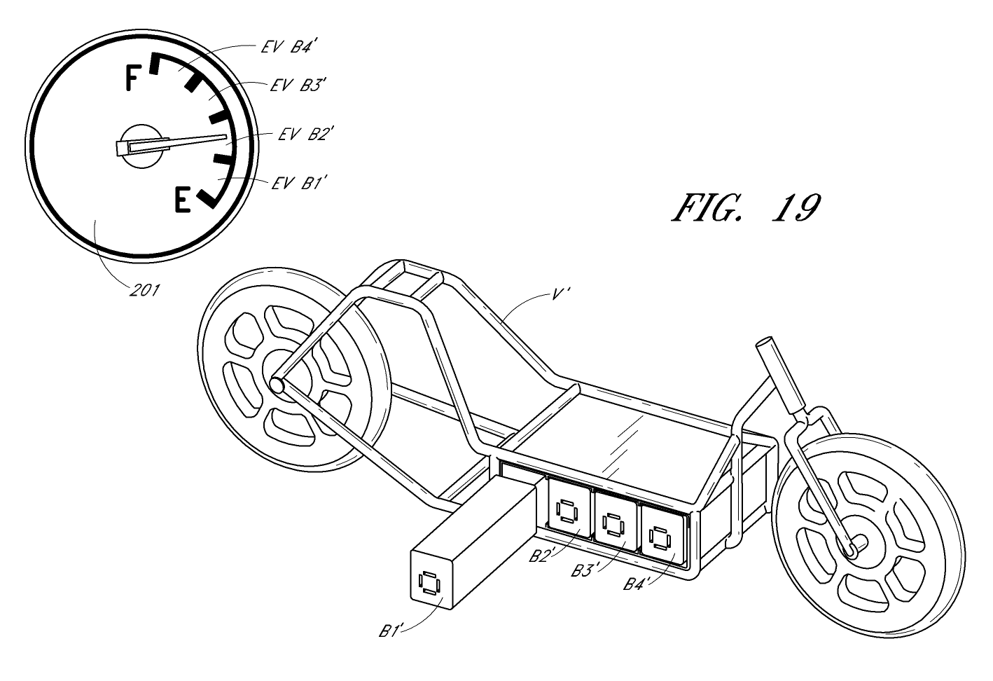

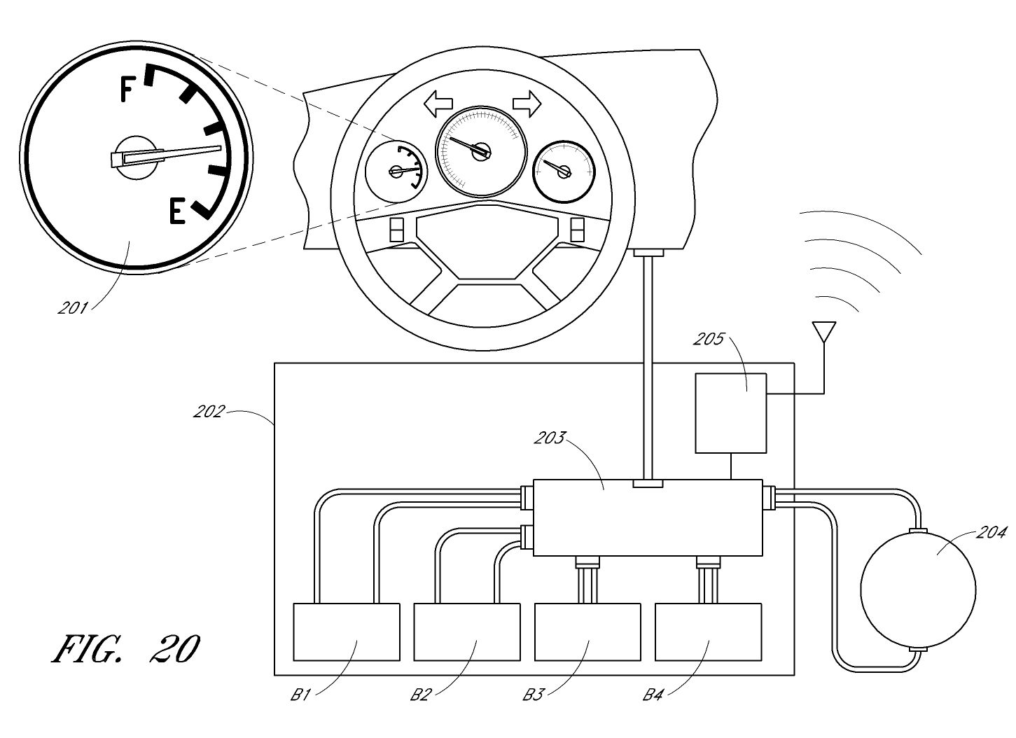

The multiple battery system, such as the embodiments illustrated in FIGS. 18 and 19, would permit one battery at a time to be used until completely depleted and then automatically switch the motor(s) to the next battery. FIG. 18 shows one embodiment of an electric vehicle V comprising four batteries B1, B2, B3 and B4. In this embodiment, the batteries are installed generally laterally in the vehicle and each battery can store a quarter of the total energy that can be carried by the vehicle. A gauge may be provided that shows the driver the charge status of each battery, as illustrated by the gauge 201 in the upper left portion of the figure. Each separate battery is represented as a quarter of the batteries fuel gauge. FIG. 19 similarly shows one embodiment of an electric motorscooter V′ comprising four batteries B1′, B2′, B3′ and B4′. The batteries are installed laterally in the motorscooter in a lower part of the motorscooter frame between the wheels. FIG. 19 also illustrates an embodiment of a gauge 201 similar to the one disclosed above.

For example, a vehicle with four batteries can use the first battery until it is completely depleted. Then, the vehicle can use the second battery until it is completely depleted, and so on. At any time between the time when the first battery is completely depleted and when the fourth battery is completely depleted, the driver can visit a battery transfer station for battery replenishment. In such an embodiment, up to three discharged batteries can be exchanged while continuing to use the fourth battery. This helps to avoid situations where a driver is forced to replace a partially charged battery for a fully charged battery to reach the next nearest battery transfer station, or situations where a driver replaces the partially charged battery because it is more convenient than waiting for the battery to discharge completely. Driving an electric vehicle until the single battery is completely depleted is impractical and could leave the driver stranded at random locations. A driver may relinquish the unused charge in a partially depleted single battery without credit or compensation, which can amount to a large sum of money when cumulated over several battery exchanges.

In addition, being able to fully discharge a battery before recharging prolongs the usable life of the battery by avoiding a “memory effect” in the battery, which is an effect observed in some rechargeable batteries where the batteries gradually lose their maximum energy capacity if they are repeatedly recharged after being only partially discharged.

Also, because the batteries are smaller and lighter, the battery exchanging mechanism of the battery transfer station can be smaller and lighter and/or endure less wear due to lighter loads. These factors can contribute to a lower cost for building and/or operating the battery transfer station.

### Multiple Batteries/Configuration

One embodiment of the battery management system contemplates that an electric vehicle is provided with a battery pack in a relatively long and broad, but flat form, which can be laterally installed in the vehicle. Suitable batteries in other embodiments can have different shapes. The battery pack may be a composite of a series of smaller batteries in a pack or box with an overall dimension of, for example, 5′ wide, 5′ long and 9″ in height for use in larger vehicles, such as the vehicle illustrated in FIG. 18. In another embodiment, the battery pack may be a composite of a series of even smaller batteries in a pack or box with an overall dimension of, for example, 2′ wide, 2′ long and 1.5″ in height that may be suitable for use in smaller electrically powered vehicles, such as an electric motorscooter illustrated in FIG. 19. Two, three, four or more discrete batteries can be removed or installed into a single vehicle. The use of multiple batteries contained in separate units may be desirable from an engineering or aesthetic design standpoint, depending upon the automobile configuration and the total volume of battery desired. In addition, a principal running battery and a separate reserve battery may be desirable from a consumer convenience standpoint. Preferably, the batteries in a single vehicle are of the same shape and size.

In any case, each individual battery can readily be displaced laterally from the vehicle, such as by laterally forcing a fresh battery into one of the battery seats in the vehicle or by laterally exchanging the battery using a sprocket, belt or other mechanism. In the battery seat, contact of the battery terminals with the drive motor for the vehicle is automatically established.

In certain preferred embodiments, the batteries are positioned to be transverse to the longitudinal axis of the vehicle. In other words, the batteries cross and are not parallel to the line that runs from the front center of the vehicle to the back center of the vehicle. In some embodiments, the batteries are generally perpendicular to the longitudinal axis of the vehicle. Two non-limiting examples of such an embodiment are illustrated in FIGS. 18 and 19. FIG. 18 depicts an electric vehicle V where the battery pack includes four individual batteries B1, B2, B3 and B4 that are installed generally perpendicular to the longitudinal axis of the vehicle. FIG. 19 depicts an electric motorscooter V′ where the battery pack is again comprised of four smaller batteries B1′, B2′, B3′ and B4′ that are placed generally perpendicular to the longitudinal axis of the motorscooter. One advantage of this type of placement is that in the case of a frontal or rear-end collision the battery (or batteries) closest to the site of impact may help to cushion the other battery(ies), reducing battery damage and breakage. Additionally, if the batteries are mounted transversely, especially perpendicularly (or approximately so), to the longitudinal axis, it can be easier to remove and replace the batteries individually, as one end of each battery is accessible from either side (left or right, e.g. driver or passenger side) of the vehicle, in addition to being accessible from the bottom of the vehicle. This also allows for a single exchange station site to more easily accommodate vehicles of many shapes and sizes. Furthermore, by having the mounting and restraining systems adapted for removal of the batteries from the side and/or bottom of the vehicle, there should be less wear and tear on such mounting and restraining systems from the routine stopping and accelerating motions of the vehicle that exert forces primarily parallel to the longitudinal axis.

Notwithstanding the advantages of mounting the batteries in a generally perpendicular orientation to the longitudinal axis of the vehicle, other embodiments may orient the batteries to be generally parallel to the longitudinal axis of the vehicle. One advantage of this type of placement is that in the case of a driver side or passenger side collision the battery (or batteries) closest to the side of impact may help to cushion the other battery(ies), reducing battery damage and breakage. Additionally, if the batteries are mounted parallel to the longitudinal axis, they can be removed and replaced individually from either the front or the rear of the vehicle, in addition to being accessible from the bottom of the vehicle.

Also, in the parallel configuration, the individual batteries can still be exchanged from either the left or right side of the vehicle. This may be accomplished by displacing each battery in the battery pack by one position so that a fresh battery is installed on one side of the battery pack and the spent battery is ejected from the other side of the battery pack. For example, a vehicle with batteries that are generally parallel to the longitudinal axis of the vehicle may use the leftmost (driver side) battery first. After the leftmost battery is depleted, the vehicle will then use the next battery that is immediately to the right of the leftmost battery. The vehicle in this example will continue in this fashion so as to use the batteries in a sequential order from the leftmost (driver side) battery to the rightmost (passenger side) battery. When the vehicle enters a battery transfer station, as of the type disclosed below, a single charged battery is installed in the right side of the battery pack. This new battery will displace the existing rightmost battery by one position to the left in the battery pack. A chain reaction may cause the adjacent batteries to displace by one position to the left. The leftmost battery, which is completely depleted, is ejected out the left side of the battery pack and carried by the battery transfer station for inspection and recharge. If another spent battery needs to be replaced, another freshly charged battery is installed on the right side of the battery pack and the next leftmost battery in the battery pack is ejected out the left side of the battery pack. This process repeats until the leftmost battery in the battery pack does not need to be exchanged.

Although the battery configuration has been described in terms of certain preferred embodiments, other embodiments of the battery pack that are apparent to those of ordinary skill in the art in view of the disclosure herein are also within the scope of this invention.

### Battery Control System

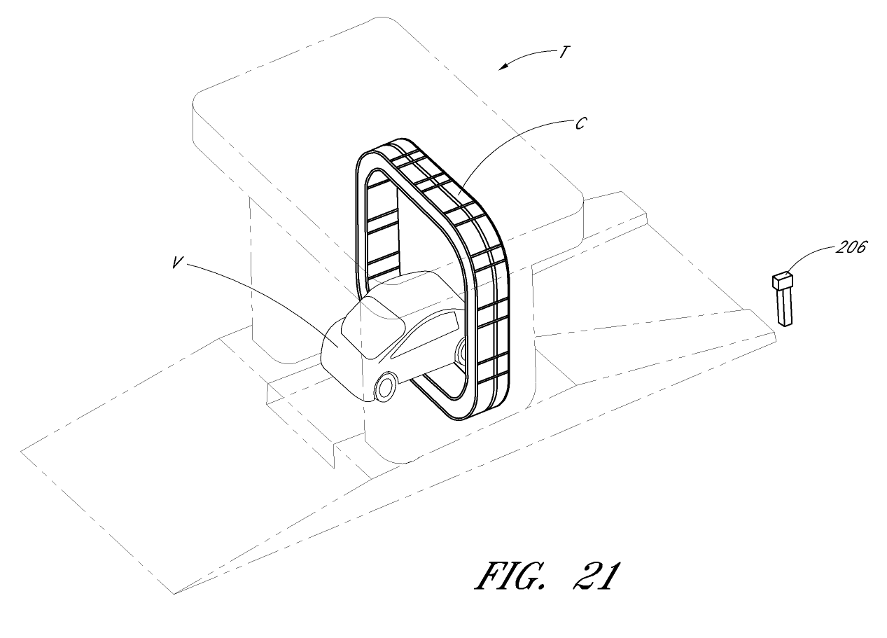

The battery management system is equipped with a battery control system that monitors the status of the batteries. One embodiment of such a control system, utilizing four batteries and wireless communication, is the system shown in schematic form in FIG. 20. The battery control system 202 in this figure comprises a controller 203 connected to four batteries B1, B2, B3 and B4, an electric motor 204, a battery fuel gauge 201, and an element for communicating 205 with the battery transfer station. Some of, but not limited to, the functions that the battery control system 202 may perform are the functions of selecting which battery to use, updating a battery fuel gauge 201 that can be monitored by the driver, providing an alert when battery power runs low, and/or directing the energy stored by the battery to a motor 204. In some embodiments, a larger system can perform one or more additional battery monitoring functions with added modules or separate components. Although FIG. 20 has been described in terms of certain preferred embodiments, other embodiments of the battery control system 202 that are apparent to those of ordinary skill in the art in view of the disclosure herein are also within the scope of this invention.

In some embodiments, the battery control system 202 in the vehicle communicates with the transfer station by wireless (e.g. transmitter or transponder) or wire (e.g. by a physical connection to the transfer station) to provide information as to which batteries are depleted and require exchange. The wireless communication may include, for example, an RF (radio frequency) transceiver which communicates bi-directionally with vehicle transponders of the type commonly used for making toll road payments. The battery transfer station T receives information from a vehicle's battery control system 202, which can include the position of the batteries which are depleted and the performance history of the batteries to be exchanged. The battery transfer station T then exchanges the select depleted batteries and may record their performance histories in its computer. In some embodiments, the driver of the vehicle may provide instruction, such as to replace a battery which is not fully depleted. The cost to the driver (or person who holds an account for the vehicle) is usually only for the batteries which are exchanged. Should the system be set up to exchange all batteries regardless of charge status, the cost would only be for those batteries which were fully or partially depleted. The cost of a partially depleted battery is preferably proportional to its charge status.

The wireless or wired communication between the vehicle V and battery transfer station T may also include information as to an account number to provide for payment for the exchanged batteries. It may also communicate any other useful information, including, but not limited to, information as to the performance of the battery during use (which may be used to determine if the battery is in need of repair or needs to be taken out of service) and/or information as to the type of battery used by the vehicle (in the event that there are different sizes and/or types of batteries dispensed by the station).

### Battery Transfer Station

To facilitate the exchange of batteries, the battery management system includes a battery transfer station T into which a standardized vehicle V can be driven. In some embodiments, as the vehicle V approaches the battery transfer station T, a battery control system 202 in the vehicle reports the battery status to the battery transfer station T so that the transfer station T recognizes which batteries within the vehicle's battery pack require exchange. The standardized vehicle may be an automobile, a motorscooter, or any other battery powered, electric motor vehicle. The vehicle may have at least two battery seats for containing multiple batteries with an overall dimension that is relatively flat and broad. A charged battery can be shifted laterally into position within one of the battery seats. In some embodiments, as the charged battery is shifted into position, the charged battery comes into contact with an existing battery and laterally forces the existing battery out of a battery seat to a receiving means. Sprockets of the receiving means may engage with notches on the bottom surface of the existing battery as the existing battery is displaced from the battery seat. The sprockets complete the removal of the existing battery from the vehicle. In other embodiments, removal of the battery may be accomplished in-whole or-in-part using drive sprockets in the floor of the battery compartment which engage with the notches on the battery. These sprockets may be powered using an external energy source which is coupled to the vehicle (via a slidably-engaging electrical connector) when the vehicle initially enters the charging station. Alternatively, the battery itself may be partially exposed on its underside, and the sprockets may engage with the notches in the battery by rising up from the base of the transfer station. The spent battery can be tested, rejected if unfit for recharge, or recharged in sequence with other batteries, while being transported through charging locations to the transfer station, for installation in a later vehicle.

Also, the battery transfer stations T are preferably modular in construction. This may enable a transfer station to be erected with low initial investment cost, and subsequently enlarged as demand increases to facilitate growth of a system of battery transfer stations. In addition, capacity upgrades through modular expansion allow the battery charging and transfer station to achieve maximum productivity. Modular expansion can also provide increased capacity without the need for, or added expense of additional space. This may provide a tremendous competitive advantage in locations where space to construct additional transfer stations is sparse.

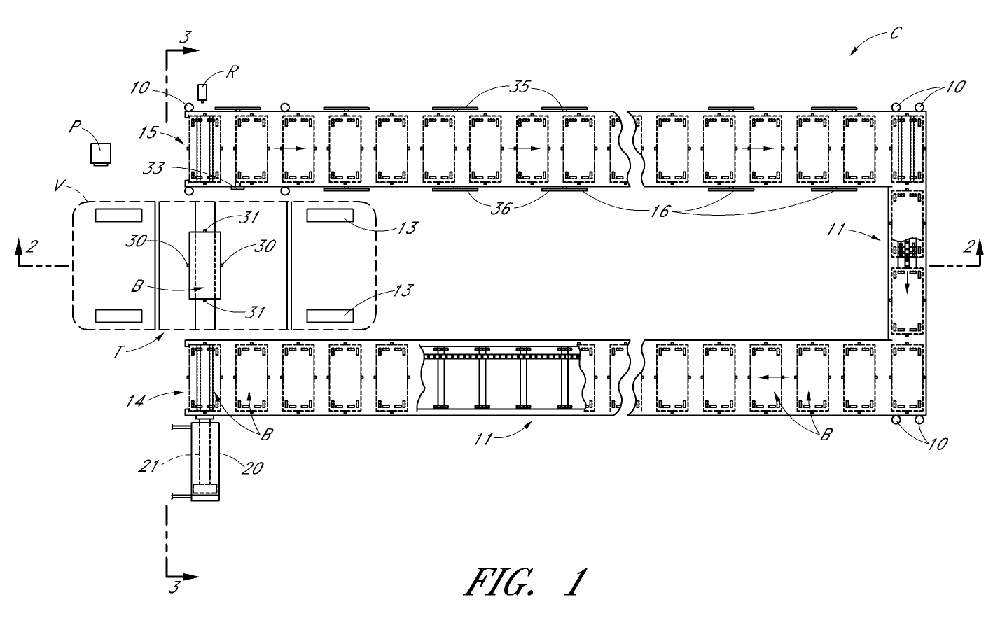

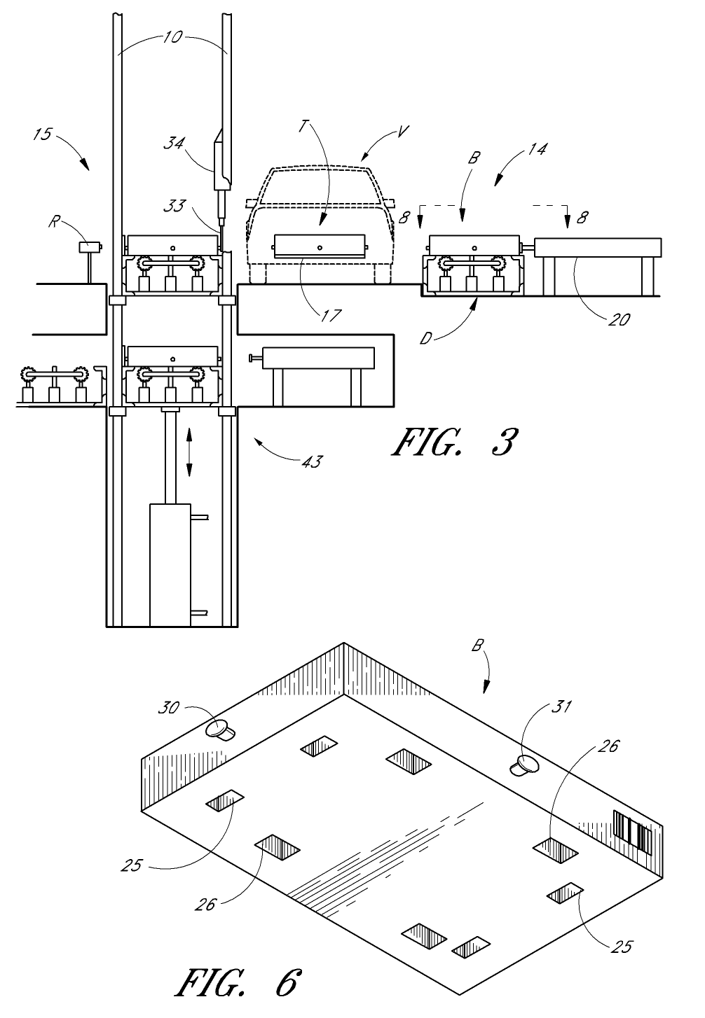

FIGS. 1-3 illustrate the general layout and structure of a preferred embodiment of a battery charging and transfer station. As best illustrated by FIG. 1, this embodiment of the station comprises a continuous battery conveyor loop C which extends from one side of a vehicle station (shown with a vehicle V positioned therein) to the opposite side of the vehicle station. Batteries B move through the conveyor loop from a receiving end or station 15 of the conveyor to a delivery end 14 of the conveyor while being charged via multiple battery chargers 16. The system also includes a transfer station or apparatus T which laterally shifts a fresh (charged) battery into the battery compartment 17 (FIG. 3) of the vehicle V from the delivery end 14 (as described below) while displacing an existing (discharged or partially discharged) battery from the vehicle and onto the receiving end 15 of the conveyor.

As illustrated in FIG. 1, the battery chargers 16 may be positioned along the conveyor C at respective battery resting locations (“battery locations”) to recharge the batteries as they are conveyed from the receiving end 15 to the delivery end 14 of the conveyor. In one embodiment, a battery charging station 16 is provided at each battery location along the two longitudinal runs or segments of the conveyor C. As described below, the battery position at the receiving end 15 of the conveyor may serve as a battery testing and removal station for (i) determining whether each extracted battery can be effectively recharged, and (ii) removing bad batteries from the system.

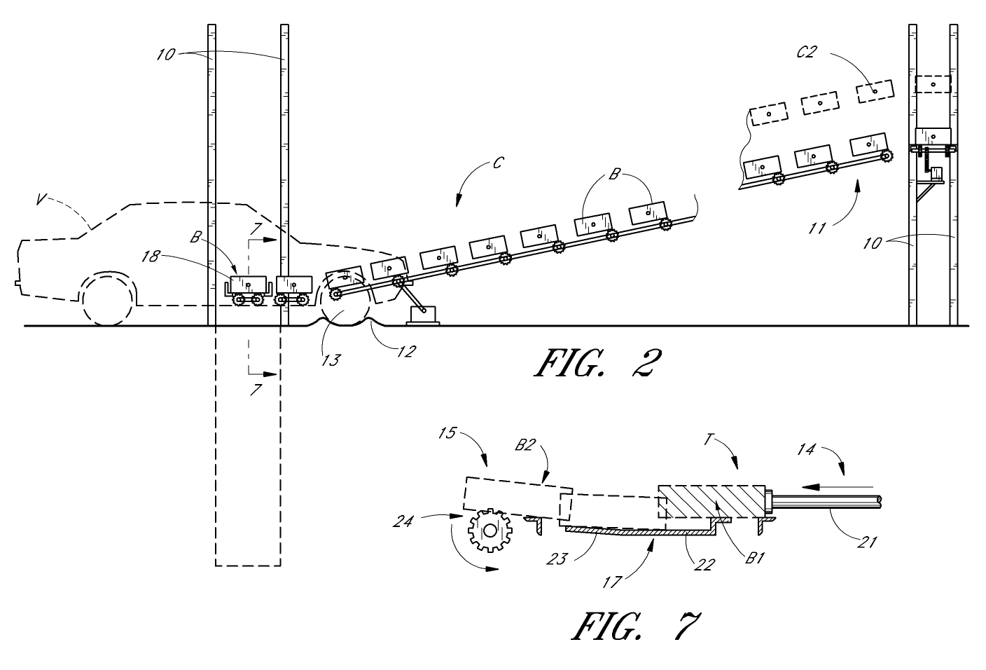

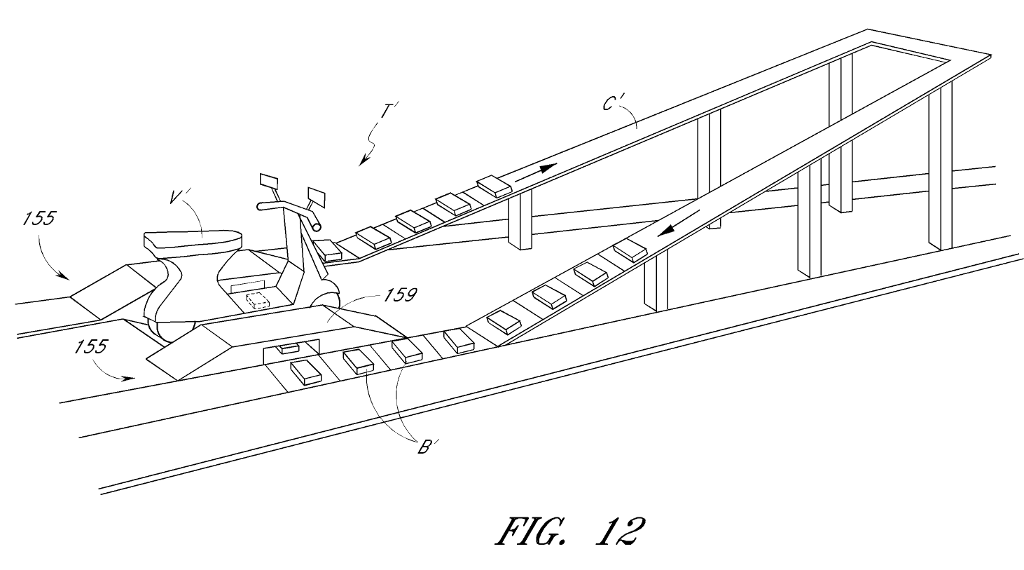

As illustrated in FIG. 2, the conveyor structure preferably includes a number of vertical support posts 10, on which a frame structure 11 is mounted in a suitable fashion. The posts 10 extend vertically to enable the application thereto of one or more of vertically-spaced expansion modules C2, as further illustrated in FIG. 10 (discussed below). Each expansion module may comprise a conveyor loop which is substantially identical in structure and operation to the conveyor loop C described herein.

As further illustrated in FIG. 2, the transfer station T may include a positioning structure 12, shown as a receptacle for the front wheels 13 of the vehicle V, which provides a stop for a vehicle driven into the transfer station T, whereby vehicles of standard length are uniformly longitudinally positioned in the transfer station. In one embodiment, the positioning structure 12 is adjustable and can move the vehicle V in the longitudinal direction to align the several individual spent batteries with the battery receiving and delivery ends of the battery transfer conveyor. In another embodiment, plural positioning structures 12 may be provided at the spaced locations for vehicles of different lengths. As illustrated in FIG. 3, the battery compartment 17 of the vehicle may extend through the vehicle below the passenger compartment from one side of the vehicle to the other. As illustrated in FIGS. 1 and 3, a hydraulic ram 20 or other shifting means can be utilized, in combination with drive sprockets which engage with notches on the batteries (as described below), to shift a charged battery from the conveyor and into the vehicle V. As further described below, the incoming battery displaces the existing vehicle battery from the battery compartment 17 to a sufficient degree to permit a set of drive sprockets at the receiving end 15 of the conveyor to complete the removal of the existing battery. Alternatively, lateral battery displacement may be performed entirely through the use of drive sprockets without the use of a hydraulic ram. As illustrated by FIG. 1, the conveyor structure may extend longitudinally from the receiving end 15, thence transversely and in a return run to the delivery end 14. Thus, lateral space to accommodate the vehicle between longitudinal runs is provided.

In some embodiments, as illustrated in FIG. 2, the transverse section of the conveyor loop (i.e., the segment which connects the two, parallel longitudinal segments) is elevated, with the longitudinal segments upwardly inclined from the transfer station T to the transverse segment. This allows vehicles to drive beneath the elevated, transverse section (between the vertical support posts 10) following battery exchange. Alternatively, the transverse section readily can be positioned beneath the path of the exiting car, if desired. This conveyor arrangement allows vehicles to enter and exit the system without reversing direction, and thus allows vehicles to efficiently pass through the system in a sequential fashion.

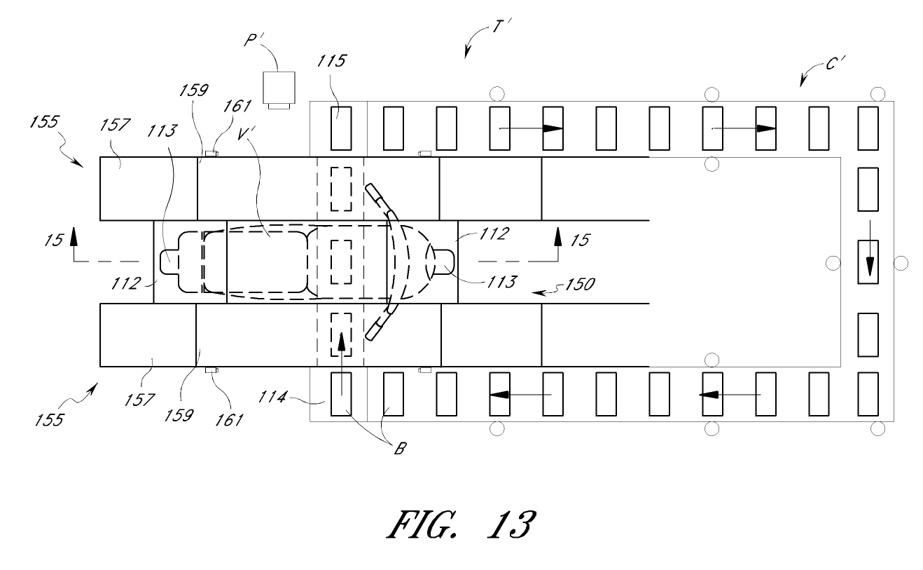

With reference to FIG. 3, the system may include a battery elevator assembly 43 which allows the extracted battery to be shifted vertically relative to the conveyor C following removal from the vehicle. The elevator assembly 43 operates in cooperation with a battery removal assembly 44 to remove batteries from the conveyor system, such as when the extracted battery fails a battery test. The elevator assembly 43 may also be coupled to a battery insertion assembly (not shown) for inserting new batteries into the conveyor system to replace discarded batteries. In implementations which include one or more expansion modules C2 (as in FIGS. 10 and 11), the elevator assembly 43 may also be used to move batteries between the multiple conveyor levels, as further described below. A second battery elevator may be provided at the battery delivery end 14 of the conveyor, as illustrated in FIGS. 10 and 11.

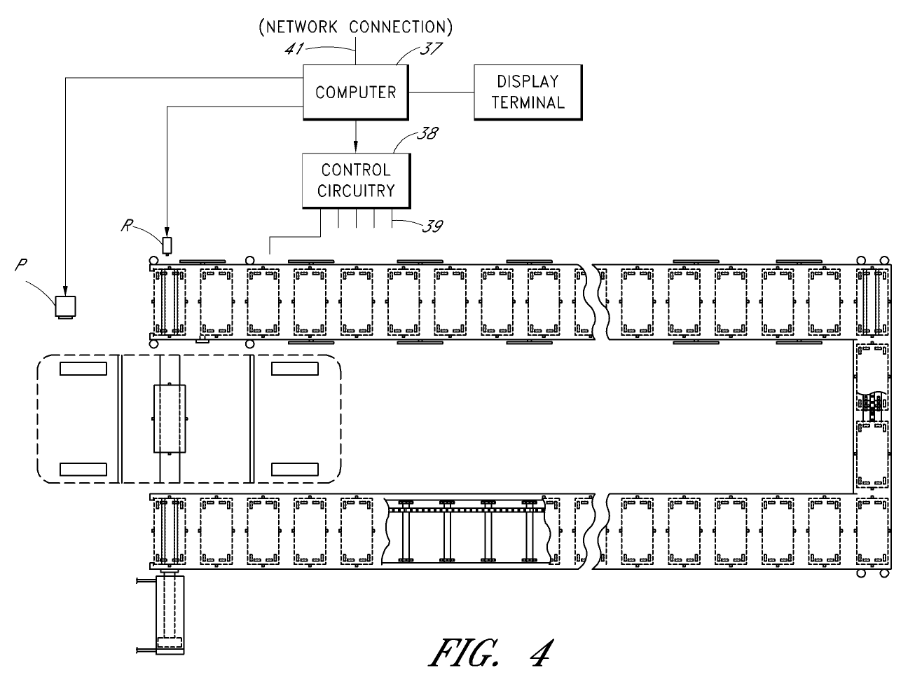

As depicted in FIG. 4, the system may include a computer 37 which controls the operation of the conveyor via conventional control circuitry 38. The control circuitry 38 may be in the form of one or more standard add-on cards which plug into expansion slots of the computer. The control circuitry 38 is coupled to the various electrically-actuated components of the conveyor and elevator assemblies via respective control lines 39, which carry control signals generated by the control circuitry in response to commands from the computer 37.

The computer 37 is preferably coupled to an electronic payment system P (FIGS. 4 and 10) which allows an operator of the vehicle V to enter payment information for paying a fee associated with the exchange of a battery. In one embodiment, the electronic payment system P automatically receives the payment information from the battery control system through a wireless or wired communication. In another embodiment, the payment system P may comprise a magnetic card reader in combination with a standard keypad (not shown) so that the operator can manually enter the payment information.

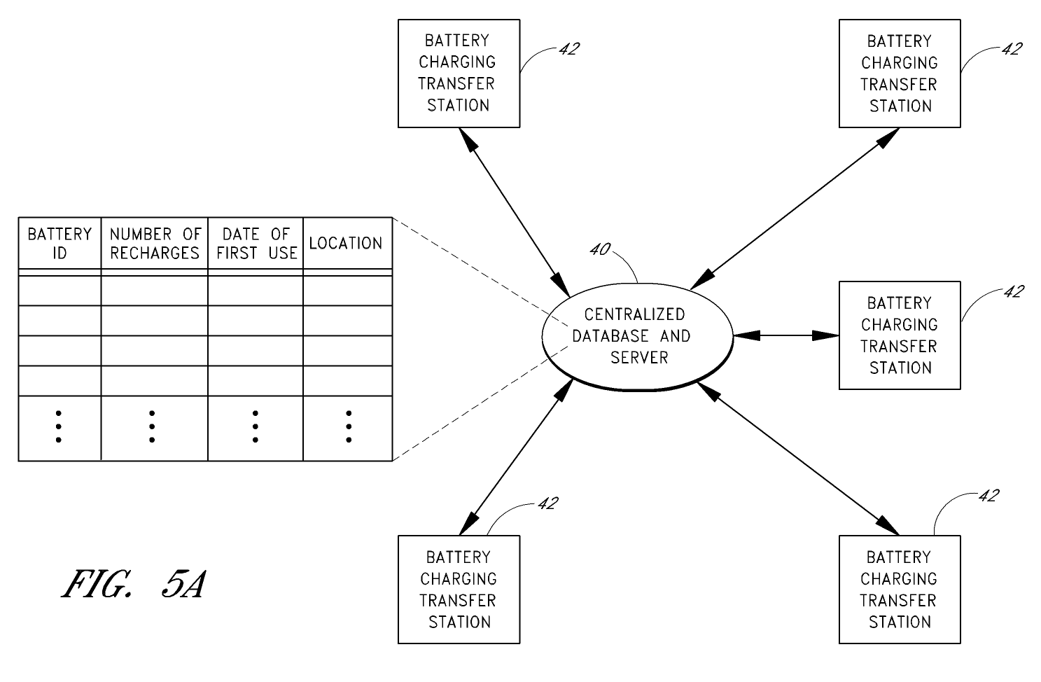

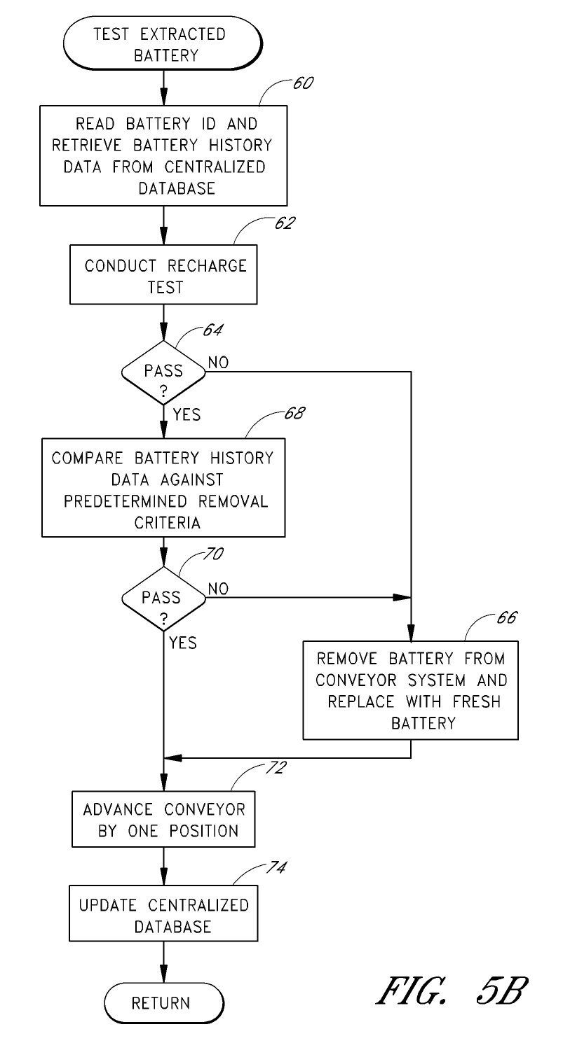

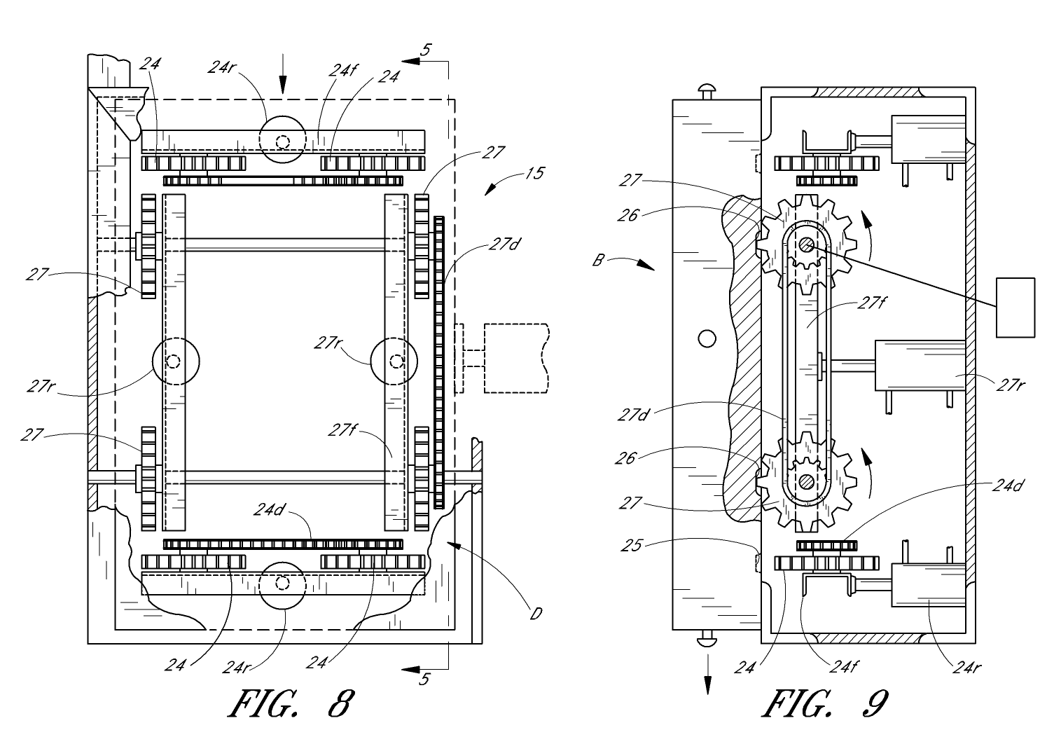

The computer 37 in FIG. 4 is also preferably coupled to at least one bar code reader R, which is positioned along the conveyor to read bar code labels (FIG. 6) on the batteries. The bar code labels may include battery ID codes which uniquely identify the batteries of the system. In one embodiment, the computer uses these ID codes to access a centralized database and server 40 (FIG. 5A) via a network connection 41, such as a continuous connection to the Internet. As will be appreciated by those skilled in the art, other types of electronic sensing systems can be used in place of the disclosed bar code system. For example, the batteries could be provided with small, embedded RF transmitters, such as MicroStamp™ transmitters available from Micron Communications Inc., which transmit ID codes to a base RF receiver of the station.

With reference to FIG. 5A, the centralized database 40 may be accessed by the respective computers of multiple, geographically-distributed battery charging and transfer stations 42 (preferably of the same construction as described herein). As further illustrated, the database may include battery tracking and history information (“history data”) which is stored, on a battery-specific basis, in association with the unique ID codes of the batteries. For each battery, this information may include, for example, the number of times the battery has been recharged, the date of first use within a vehicle, and the current location (e.g., charging station or vehicle) of the battery. When a given battery is located within a vehicle, the location information may include information about vehicle (such as a vehicle ID number) and/or the vehicle's driver (such as the driver's credit card number). Updates to the database 40 can be made remotely from the battery charging/transfer stations 42 by sending update requests across the network to the server associated with the database. These update requests are generated by the computers 37 of the individual stations in response to battery exchange operations.

As further described below, whenever a discharged battery is removed from a vehicle, the computer 37 of the respective station 42 may read the battery's ID code, and then access the centralized database to retrieve the battery's history data. The computer 37 can then uses this information, in addition to the results of an electrical battery test, to determine whether or not the battery should be discarded or otherwise removed from the system. This allows the decision of whether or not to discard the battery to be based on multiple criteria.

While one embodiment uses a centralized database 40 to store battery history data, it will be recognized that other storage methods are possible. For example, the batteries readily can be adapted to store and provide access to their own respective history data via conventional solid state storage devices located with the battery housing. This approach reduces or eliminates the need for a centralized database 40, but does not provide the battery tracking capabilities of the centralized database approach. It will also be recognized that conventional caching techniques can be used to locally store respective copies of the history database 40 at the transfer stations 42, so that accesses to the centralized database 40 need not be performed each time a battery is exchanged.

The actual battery exchanges in the vehicle can be accomplished in any of a variety of alternative ways, depending upon the configuration of the batteries and the vehicle's battery receiving structures. For example, instead of forcible displacement of the installed discharged battery with a new charged battery, the installed discharged battery can be previously removed such as by a sprocket as will be discussed infra. In addition, although one embodiment utilizes a lateral, horizontal installation and removal of the battery, variations will become apparent to one of ordinary skill in the art in view of the disclosure herein and the desired battery compartment configuration for the vehicle.

The battery seats in the vehicle as in FIG. 7 can be structured to provide retention means to prevent lateral movement of the batteries from the seats, except at the transfer station where suitable displacement means 16, such as the ram 20 is provided. Any of a variety of retention structures can be provided, depending upon the battery design and battery seat design. For example, one or more vertically extending ridges or projections can be provided at the installation side and/or the exit side of the batteries to provide a stop over which the batteries must travel to exit the car. The stop can be permanently positioned, or movable between a “locked” and “unlocked” position. Alternatively, any of a variety of battery compartment hatches can be used, which will normally be locked shut except during the battery exchange process. In the illustrated embodiment, the battery seats 22 (FIG. 7) is provided with a shoulder on the installation side of the seat, to prevent movement of the battery in the reverse direction.

Alternatively, the underside of the battery may be exposed while situated in the vehicle, so that laterally spaced sprockets may engage from an area directly below the battery's underside, without the need for the vehicle to be equipped with drive sprockets. Optionally, this embodiment can be configured to upwardly lift the battery from the battery seat prior to shifting. Additional details of this embodiment are discussed above.

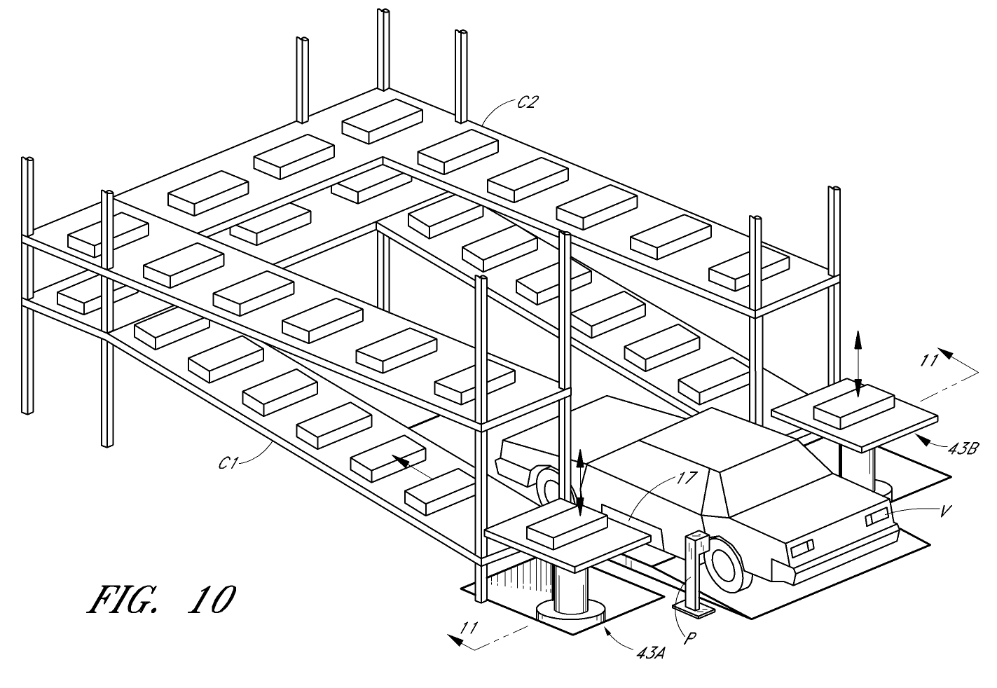

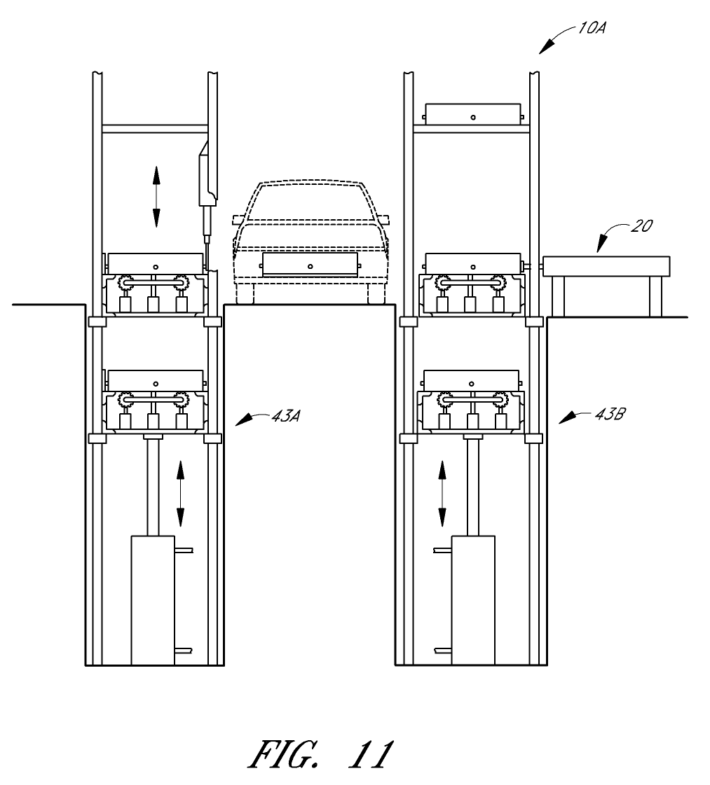

Drive means D, shown in FIG. 8, may be provided to assist the lateral movement of spent batteries from the vehicle. Such drive means D may include, as partially shown in FIG. 7, driven sprocket means 24 adapted to engage in notches or recesses 25 (FIG. 6) on the bottom surface of batteries, to complete the transfer of batteries B2 from the vehicle onto the receiving station 15. The notches 25 are located preferably adjacent to the opposite ends of the batteries B, and provide sprocket abutments enabling lateral drive of the batteries. The underside of the batteries may also have laterally spaced sprocket receiving recesses 26, providing abutments engagable by additional drive sprockets 27 (FIGS. 8 and 9) adapted to engage and shift the batteries progressively through the charging stations in a lateral direction perpendicular to the direction of displacement. As is apparent from the figures, the notches 25, 26 illustrated in FIGS. 6 and 9 are representative of respective rows of notches which extend along the bottom surface of the batteries.

With reference to FIGS. 1 and 6, the transverse drive notches 25 in the batteries may be used by the conveyor system to laterally shift batteries from one longitudinal segment to the other longitudinal segment along the segment denoted generally by reference number 11. As best seen in FIGS. 8 and 9, because the transverse drive sprockets 24 and the longitudinal drive sprockets 27 cannot be simultaneously engaged with batteries, the sprockets 24 and drive means 24d are mounted on a frame structure 24f which is selectively vertically shifted by a ram 24r. Likewise a ram 27r vertically shifts the sprocket frame structure 27f and sprocket drive 27d. Thus, the sprockets 24 and 27 are selectively engagable with the battery drive recesses 25 and 26.

Alternatively, any of a variety of engagement structures can be provided on the batteries, to enable engagement with the drive mechanism of the transfer station. The use of a particular structure, such as hooks, rings, projections or recesses will depend upon the load of the batteries to be transferred, the static friction or structural stop to be overcome in removing the batteries, and the direction of removal, such as horizontal plane or vertical lift as will be readily apparent to one of skill in the art. In general, the engagement structures are preferably relatively low profile to minimize the opportunity for inadvertent interlocking with other batteries or parts of the system, and yet permit transfer of sufficient force to manipulate the batteries through the transfer station. For this purpose, one embodiment comprises a plurality of spaced recesses on the battery housings, to be engaged by a sprocket as illustrated, or other engagement structure on the drive mechanism.

FIGS. 10 and 11 illustrate other embodiments in which additional conveyor loops or modules are added to the system to increase battery capacity. The illustrated system includes a main conveyor loop C1, and an expansion conveyor loop C2 which is positioned above the main conveyor loop. Both conveyor loops are substantially identical to the conveyor loop C described above. Additional expansion conveyors can be added as needed to accommodate demand. In one embodiment, both conveyor loops include charging stations (not shown) positioned along their respective longitudinal segments. Battery elevators 43A and 43B may be provided at opposite ends of the two conveyor loops C1, C2 to permit the vertical movement of batteries between the two conveyor levels. Both conveyor loops C1, C2 preferably include battery chargers along their respective longitudinal segments, preferably at each battery position.

FIG. 21 depicts another embodiment of a battery transfer conveyor where the conveyor loop extends vertically above the vehicle, rather than in front of or behind the vehicle. FIG. 21 shows a vehicle V at a battery transfer station T where the conveyor C creates a loop directly above the vehicle. The conveyor path is illustrated in dark colors in the figure. The battery transfer station T is controlled by computer and charges each battery after exchange. In some embodiments, the time to charge can be 2-3 hours. A pay station 206 is provided where the driver can enter battery status and payment information.

Preferably the batteries are carried vertically along the charging conveyor through the use of latches. For example, the latches can engage with the notches or recesses in the underside of the battery to carry the battery vertically upwards and downwards along the conveyor belt. Alternatively, the latches may contact the battery along the edge or corner without engaging with the notches or recesses. Lateral movement of the battery across the top of the conveyor can be accomplished using a sprocket mechanism like that disclosed herein. As will be appreciated by those skilled in the art, any combination of latches, pulleys, belts, and sprockets can be utilized to carry the batteries along the conveyor loop.

The vertical embodiment just described also provides for increased battery capacity by optionally adding vertical conveyor loops or modules successively in front of an existing conveyor loop. Preferably, each additional conveyor loop would be no more than a few feet in front of the previous conveyor loop, thus increasing capacity without sacrificing space.

Also, the batteries readily can be adapted for vertical removal from the automobile followed by vertical installation of the new batteries. A discharged battery may be vertically removed from the vehicle and a fully charged battery may be installed vertically. This alternative embodiment of the battery transfer station is similar to the other embodiments, except that the freshly charged batteries are staged below the electric vehicle for installation. A lift vertically lowers the spent batteries from the vehicle and installs the charged batteries by lifting it vertically into the battery seat of the vehicle. An advantage of this embodiment is that it is a more compact system, suitable in space-limited geographic regions.

Similarly, the battery readily can be horizontally removed along an axial direction such as from the rear of the car or from the front of the car. The precise location and mode of removal of the battery is a design consideration that can be optimized through routine experimentation by one of ordinary skill in the art, in view of such considerations as battery size, weight distribution in the vehicle, and other access considerations such as the location of doors, wheels and the like.

As illustrated by FIGS. 1 and 6, the batteries may have contact posts 30 at its opposite ends which are automatically engaged with contacts within the vehicle when the batteries are shifted into the vehicle. Also, on opposite sides of the batteries may be charging contacts 31, which are also used as test contacts. Thus, when a battery is displaced from the vehicle at the transfer station T, the displaced battery enters the receiving station or position 15, and the contact 31 on one side engages a test rail 32 (FIG. 1). Preferably, the contact posts 30 and the charging contacts 31 are connected internally. Thus, battery charging is available at all battery positions of the conveyor, including battery positions on both the longitudinal and the transverse segments of the conveyor. As best illustrated by FIG. 3, a vertically shiftable test contact 33 may be adapted to be elevated and lowered by a ram 34 at the receiving position 15, whereby the battery can be tested. With further reference to FIG. 3, the elevator assembly 43 may be coupled to the receiving station 15 to enable bad batteries to be removed from the conveyor system under the control of the computer 37. The battery removal assembly preferably may include a hydraulic ram 44 which displaces the battery from the vertically-shiftable receiving station 15 once the battery has been lowered to the level of the ram 44.

As batteries are progressively moved along the conveyor C from one battery position to another, the posts or contacts 31 (FIG. 1) may engage charging rails 35 and 36. The charging rails 35 and 36 may be controlled by a voltage regulator (not shown) so that the charge level of the batteries is controlled. Although the charging rails 35, 36 are only shown along one of the two longitudinal segments of the conveyor in FIG. 1, charging stations are preferably provided along both longitudinal segments and transverse sections.

As will be appreciated by those skilled in the art, a variety of different types of battery contacts 30, 31 can be used to reversibly place both the car and the charging station in electrical contact with the battery. In some embodiments, the contacts 30, 31 are retractable, spring-loaded members which retract into the housing of the battery in response to a physical driving force. In other embodiments, conductive contact surfaces either above or below the adjacent surface of the battery can be used in place of the retractable contacts. Alternatively, any of a variety of plugs, clips, conductive cables and the like can be used. FIG. 17 best illustrates an alternative embodiment of the battery with elongated electrical contacts 30, 31 on the sides of the battery. The battery in FIG. 17 further depicts the recesses or notches 126 on the underside of the battery for use with a sprocket drive mechanism.

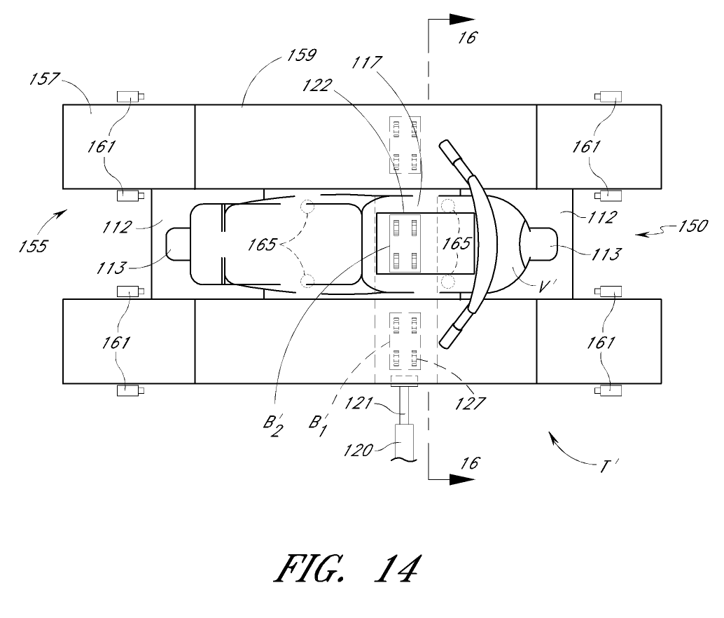

A motorscooter embodiment of the battery transfer and charging system will now be described with reference to FIGS. 12-17, and 23. FIG. 12 illustrates the general layout and structure of a motorscooter battery charging and transfer system in accordance with one embodiment. The motorscooter system is a variation of the automobile battery charging and transfer system described above, and is specially adapted to handle a two-wheeled electric motorscooter. A preferred apparatus and method for exchanging batteries in a motorscooter will now be described, however the apparatus and method for exchanging batteries discussed above is directly applicable to the motorscooter battery transfer and charging system. As will be appreciated from the following description, the system can be adapted to handle electric motorcycles, mopeds, and other types of two-wheeled vehicles.

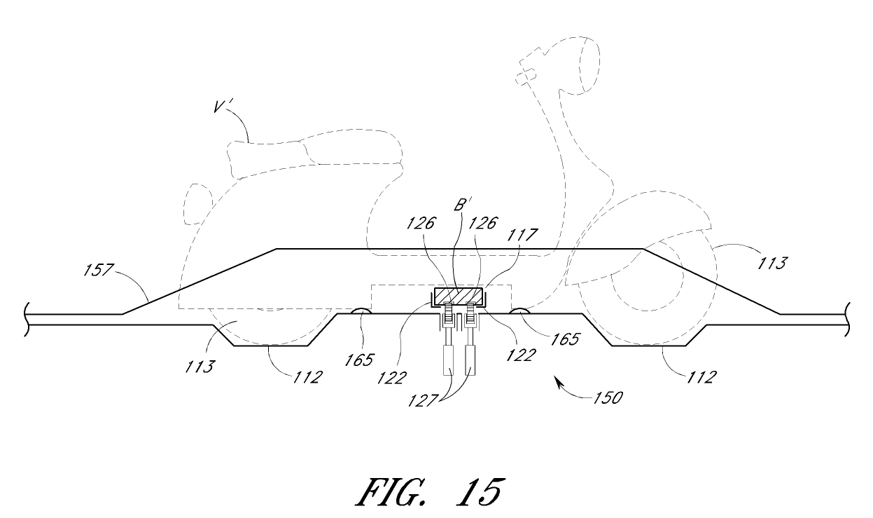

As illustrated by FIGS. 12 and 13, the system may comprise a continuous battery conveyor loop C′ which extends from one side of a vehicle station T′ (shown with a motorscooter vehicle V′ positioned therein) to the opposite side of the vehicle station T′. As in the automobile system of FIGS. 1-11, batteries B′ can move through the conveyor loop from the receiving end 115 of the conveyor to a delivery end 114 of the conveyor while being charged via multiple battery chargers (not shown). In this embodiment, however, the conveyor loop C′ passes under an elevated support area 155 located on both sides of the vehicle. The elevated support area on each side of the vehicle is preferably identical in structure.

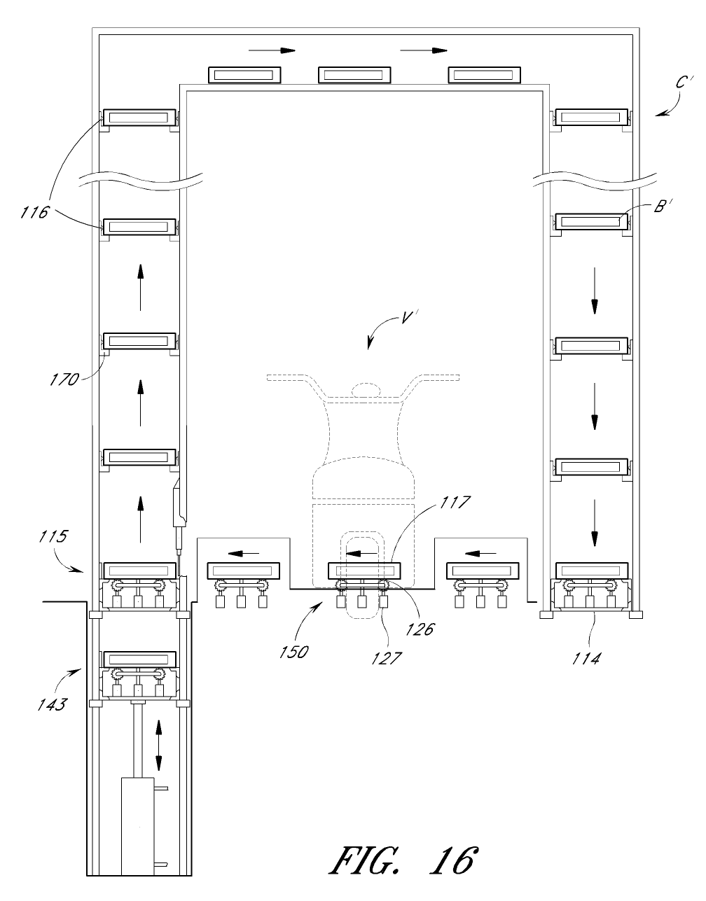

As illustrated in FIGS. 14 and 15, the battery compartment 117 of the vehicle may extend through the vehicle below the floor area where the operator's feet are positioned while riding the motorscooter. Preferably, electric motorscooters such as those manufactured by Kwang Yang Motor Company (KYMCO) and Piaggio SpA may be modified and equipped to provide a battery compartment as described. In addition, the battery transfer station may be readily adapted for other electric motorscooter-type vehicles, such as three-wheeled rickshaws manufactured by India's Baja Auto Limited and various four-wheeled all-terrain vehicles.

Unlike the battery exchange involving an automobile where the operator and passengers remain in the vehicle, the motorscooter system is preferably designed such that the operator of the motorscooter must dismount the vehicle during battery exchange. The elevated support area 155 may consist primarily of a landing 159 which allows the operator of the vehicle to stand above the conveyor without interfering with the battery exchange operation. In addition, the support area 155 can provide added safety for the operator of the vehicle by elevating the operator above the conveyor C′ during battery transfer. The elevated support area 155 can function in conjunction with the battery conveyor C′ to allow vehicles to enter and exit the system without reversing direction, thus allowing the vehicles to efficiently pass through the system in sequential fashion. In one particular embodiment, the vehicle operator utilizes the elevated support area to walk up the ramp 157 and place the motorscooter into position within the vehicle securing station 150. The operator remains situated on the landing 159 of the elevated support area 155 as the vehicle is positioned and secured within the vehicle securing station 150. When the battery exchange operation is complete the operator pulls the vehicle forward.

As further illustrated in FIG. 13, the electronic payment system P′ described above can be accessed while the operator is standing on the landing 159 of the elevated support area 155.

As will be appreciated by those skilled in the art, alternative embodiments may be employed in lieu of an elevated support area in order for the vehicle operator to position the motorscooter within the transfer station. For example, a conveyor mechanism or similar apparatus can be utilized to move the vehicle into position within the vehicle securing station. Alternatively, the operator can move the vehicle into position on a level surface and cross over the battery conveyor via a step, rather than a ramp, in order to preserve the sequential processing of vehicles. Alternatively, the battery exchange operation can be initiated by a transfer station operator or attendant.

As illustrated in FIG. 13, the elevated support area 155 optionally includes an optical sensor device 161 for detecting the presence of the vehicle operator on the elevated support area. The elevated support area 155 can be located on both sides of the vehicle V′ and both sides can be equipped with an optical sensor device 161, thus monitoring the presence of additional vehicle passengers or a vehicle operator utilizing the opposite ramp to position the vehicle in the transfer station T′. The sensor 161 is preferably positioned just below the surface of the landing area 159 on the elevated support 155. The sensor 161 is also preferably coupled to the computer system described above via conventional control circuitry. This sensor 161 ensures that the operator is safely away from the battery exchange conveyor area before commencing a battery exchange by monitoring the area around the elevated support area 155. When the sensor 161 detects an object in the path of the optical beam, a control signal is generated to stop the conveyor. This sensor 161 can provide an added safety feature for the motorscooter operator not required for an automobile battery exchange system. Alternatively, the sensor can monitor the presence of a transfer station attendant when the battery exchange operation is initiated or performed by an attendant.

As will be appreciated by those skilled in the art, a variety of different sensor devices may be employed to detect the presence of a person on the landing of the elevated support area. For example, detection of an operator's presence on the landing area may be achieved using an weight sensor located just below the landing surface. This sensor would be configured to measure a threshold weight before the battery exchange operation will commence.

In the embodiment depicted by FIG. 14, the transfer station T′ may include a hydraulic ram 120 having a rod 121 which laterally forces the battery B1′ into one of the battery seats 122 in the vehicle. The vehicle is positioned so that the first depleted battery B1′ is aligned with the delivery end 114 and receiving end 115 of the transfer station T′. The battery B1′ displaces the first depleted vehicle battery B2′, forcing the first depleted battery B2′ onto an exit conveyor toward the receiving end 115 of the conveyor. One or more drive sprockets 127 may be provided at the receiving end as in FIG. 7 to complete the battery exchange operation. The vehicle may then be moved longitudinally, either by an operator or attendant, or automatically by the vehicle securing station 150, to align the second depleted battery B2′ with the delivery end 114 and receiving end 115 of the transfer station T′. Another battery B1′ displaces the second depleted vehicle battery B2′, forcing the second depleted battery B2′ onto an exit conveyor toward the receiving end 115 of the conveyor. One or more drive sprockets 127 may be provided at the receiving end as in FIG. 7 to complete the battery exchange operation. This process is repeated for all the depleted batteries in the motorscooter that need exchange. Alternatively, the battery exchange operation can be initiated and manually performed by a transfer station operator or attendant.

In one embodiment as depicted by FIG. 15, drive sprockets 127 alone may be used to engage with notches 126 on the underside of the vehicle's batteries to accomplish the battery exchange. The drive sprockets are positioned below the underside of the batteries in the floor of the vehicle securing station 150. The sprockets 127 may be provided on a hydraulic vertical lift that can be raised or lowered to engage with one of the batteries located in the battery compartment 117 of the vehicle. The sprockets may then retract into the floor to allow the vehicle to exit the transfer station T′ upon completion of the exchange operation.

Optionally, this embodiment can be configured to upwardly lift one of the batteries from a battery seat 122 prior to the battery exchange operation. The battery seats 122 can provide openings that are aligned with the notches 126 in the batteries. The drive sprockets 127 provide a continuous lateral exchange of the batteries from the battery delivery end 114 to the battery receiving end 115, functioning in conjunction with the drive sprockets of the battery conveyor, as discussed above.

As illustrated in FIG. 15, the transfer station T′ may include a vehicle securing station 150 comprised of a positioning structure 112, shown as receptacles for both the front and back wheels 113 of the vehicle V′. As will be appreciated by those skilled in the art, a variety of different positioning structures can be used. If desired, the plural positioning structures 112 may be provided at various spaced locations to accommodate vehicles of different lengths. In one embodiment, the positioning structure may alternatively be placed on a roller mechanism or track for repositioning the motorscooter so that each of the several battery seats 122 are aligned with the delivery end 114 and receiving end 115 of the battery transfer station T′ for exchange.

Additionally, the inner sides of the elevated support area 155 can serve as added protection against the tipping of the vehicle V′ while properly positioned within the motorscooter securing station 150.

As further illustrated in FIG. 15, the vehicle securing station 150 may be equipped with rollers 165 located on the floor of the vehicle securing station 150 between the wheel receptacles 112. Once the vehicle V′ is positioned within the vehicle securing station 150, the base of the vehicle 167 below the battery compartment 117 rests against the rollers maintaining the balance and upright position of the motorscooter during battery transfer. Preferably, the rollers 165 extend across the entire width of the motorscooter's underside to provide maximum vehicle stability. Additional rollers can be provided to increase balance if necessary. The rollers 165 also help to assist the operator in removing the vehicle from the station upon completion of the battery transfer operation.

As will be appreciated by those skilled in the art, any of a variety of different types of support structures may be employed in place of or in addition to the rollers 165. For example, the motorscooter can be secured in place with laterally-engaging rollers which contact the vehicle from the sides. The laterally-engaging rollers may lock into place upon payment by the operator, and subsequently unlock and retract from the vehicle upon completion of the battery transfer. Another embodiment may consist of a locking hub mechanism which engages from both sides near the tires of the motorscooter to properly hold the vehicle in place during battery transfer. Preferably, the contacting surfaces of the rollers, locking hub mechanism or other support mechanism will be constructed of a material that will not damage the finish of the motorscooter.

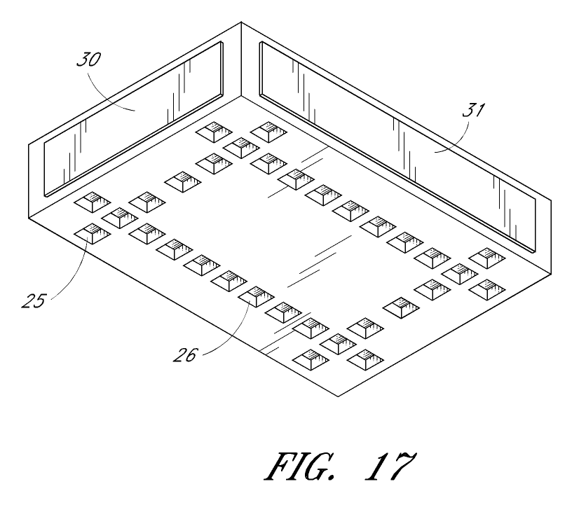

FIG. 16 is representative of an alternative embodiment of the conveyor loop, and illustrates additional details of the vertically engaging sprocket mechanism described above. In this embodiment, the conveyor loop extends vertically above the vehicle, rather than in front of or behind the vehicle. The vertical conveyor loop is depicted with a motorscooter vehicle V′ positioned and secured within the transfer station T′. Batteries B′ are continuously charged while moving along the conveyor vertically over the vehicle, rather than longitudinally in front of the vehicle. As in the embodiments discussed above, the battery receiving end 115 is equipped with a vertical battery elevator 143 for removing batteries determined to be unfit for recharge. Preferably, the batteries are shifted from the battery delivery end 114 to the battery receiving end 115, through the battery compartment 117 of the vehicle via drive sprockets 127 deployed within the vehicle securing station 150 which engage with the notches or recesses 126 on the underside of the battery. As further illustrated in FIG. 16, the battery chargers 116 may be located at various positions along the battery conveyor.

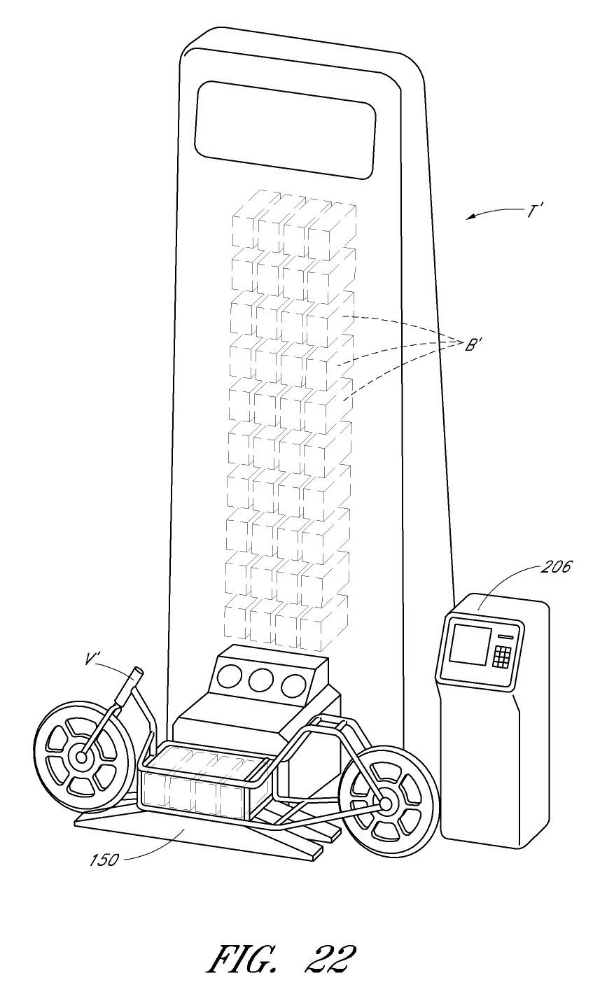

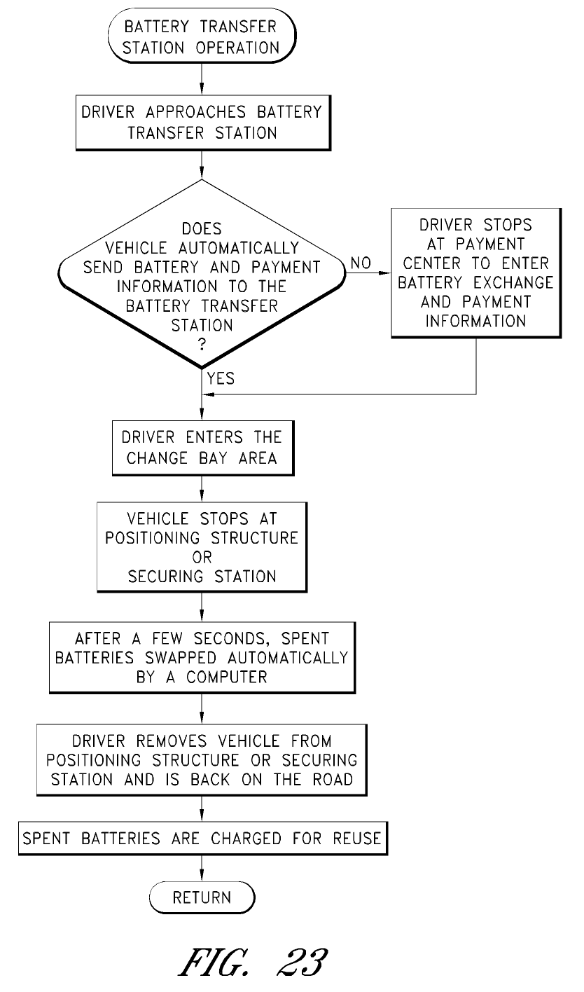

FIG. 22 shows another embodiment of the motorscooter battery transfer station T′ comprising a single vertically extending storage tower that houses freshly charged motorscooter batteries B′. The figure shows a motorscooter V′ in position at a battery transfer station T′ for battery exchange and secured by a securing station 150. The battery transfer station T′ automatically unlatches a discharged battery from the motorscooter V′. The storage tower may comprise a compartment structure with a plurality of battery charging stations that is vertically moveable. In some embodiments, the first spent battery is removed from its battery seat in the motorscooter V′ and transferred to a vacant battery charging station in the compartment structure. The structure can move vertically up or down to position a freshly charged battery B′ in the transfer position. A charged battery B′ is transferred to the empty battery seat in the vehicle. The motorscooter securing station 150 may shift the vehicle V′ to position another spent battery for transfer. The same procedure can be repeated for every spent battery in the vehicle's battery compartment.

Adaptation of the various vertical lifts, conveyors and other structural components of the battery charging and transfer system to accommodate each of these types of variations will be readily achievable by one of ordinary skill in the art in view of the disclosure herein.

### Method For Exchanging Batteries

A preferred method for exchanging batteries will now be described as illustrated in FIG. 23. An electric vehicle with a battery pack comprising at least two batteries is provided. In the first step, the driver approaches the battery transfer station. In some embodiments, the battery control system, illustrated in FIG. 20, communicates wirelessly with the battery transfer station. The information transmitted to the battery transfer station may include information such as which batteries need to be replaced, the history and type of each battery, payment information, and the type of the electric vehicle. In another embodiment, the driver may stop at a payment center and enter payment information manually, as illustrated in FIG. 23.

For automobile vehicles the next step comprises the vehicle entering the battery transfer station, as illustrated in FIG. 23. That may entail the operator driving the vehicle until the front wheels are in the positioning structure 12 of FIG. 2. After a short time, preferably a few seconds, the batteries are swapped automatically by a computer. The battery transfer process is complete and the driver may remove the automobile vehicle from the positioning structure 12 and be back on the road. The spent batteries taken from the automobile vehicle are charged for reuse.

For motorscooters, the method may entail positioning the vehicle in the securing station 150 of FIG. 13. The computer of the battery transfer station automatically replaces the discharged battery with a fully charged battery in a short time, preferably in a few seconds. Next, the driver may remove the motorscooter from the securing station 150 and ride off The spent batteries from the motorscooter are charged for reuse.

Although illustrated in one embodiment in FIG. 23, alternative embodiments may include other methods of exchanging batteries in automobile vehicles and motorscooters, as would be known to one of ordinary skill in the art in view of the disclosure herein.

In one embodiment, as illustrated by FIGS. 1 and 7, the transfer station T may include a hydraulic ram 20 having a rod 21 which extends outward to forcefully displace the battery B into the vehicle. The rod 21 laterally forces the first battery B1 (FIG. 7) into one of the battery seats 22 in the vehicle. The first battery B1 displaces the existing vehicle battery, forcing the existing battery onto an exit conveyor such as up an inclined ramp section 23 of the seat 22 toward the receiving end 15 of the conveyor. The vehicle can be moved further longitudinally so that rod 21 is aligned with another spent battery. The rod 21 laterally forces another fresh battery B2 (FIG. 7) into a battery seat 22 in the vehicle. The fresh battery B2 displaces the existing spent battery, forcing the existing spent battery onto an exit conveyor such as up an inclined ramp section 23 of the seat 22 toward the receiving end 15 of the conveyor. This process can be repeated for replacement of additional spent batteries in the electric vehicle's battery pack. After all the spent batteries are exchanged with fully charged batteries, the driver can remove the vehicle from the battery transfer station and drive off.

Although the embodiment of the system just described uses the incoming battery to forcibly displace the existing battery, other embodiments may include different battery removal methods. For example, the vehicles can be provided with drive sprockets within the battery compartment for moving batteries into and out of the battery compartment, eliminating the need to forcibly displace the existing battery. These sprockets may be powered using an external energy source which may be coupled to vehicle (via a slidably-engaging electrical connector, for example) when the vehicle initially enters the charging station. In addition, although preferably the batteries are introduced and removed in a continuous single direction path of travel, the conveyors and hydraulics of the transfer station can readily be modified by one of skill in the art to accomplish battery removal and installation from the same side of the vehicle if desired.

FIG. 5B illustrates one embodiment of the general process followed by the computer 37 each time a battery is extracted from a vehicle. As depicted by block 60, the computer 37 initially reads the battery ID code with the bar code reader R, and then accesses the centralized database 40 to retrieve the history data of the battery. In other embodiments, the history data is stored within the batteries and the history data can be communicated wirelessly or wired to the computer by the battery control system. Concurrently with the data retrieval process, the computer 37 initiates the electrical battery recharge test to determine whether the battery can be adequately recharged, as indicated by block 62. If the battery fails the recharge test, it can be removed from the conveyor C via the elevator assembly 43 and replaced with a fresh battery, as indicated by blocks 64 and 66.

With reference to blocks 68 and 70 if the battery passes the battery recharge test, the computer may perform a second battery test which involves comparing the retrieved battery history data to pre-specified removal criteria, such as a maximum number of recharges and/or a maximum duration of use. If the battery fails to satisfy the predetermined criteria, it can be removed from the system. This combination of an electrical test and a usage-history test provides a high degree of protection against the installation of bad batteries into vehicles.

With reference to blocks 72 and 74, once the battery tests have been conducted (and the battery replaced if necessary), the conveyor is advanced by one battery position. In addition, the centralized database may be updated to reflect the results of the battery tests. If the system optionally includes one or more expansion levels or modules (as in FIGS. 10 and 11), the computer 37 can also execute code for shifting batteries between the two or more levels (as described below).

In addition to the battery testing code reflected by FIG. 5B, the computer 37 can also execute code for ensuring that the batteries are sufficiently recharged before being installed into vehicles. In one embodiment, this is accomplished by keeping track, on a battery-specific basis, of the amount of time each battery has been recharged, and by ensuring that the next battery to be installed has been recharged for some minimum amount of time. (Because the batteries enter and exit the conveyor system on a first-in-first-out basis, the battery which resides at the delivery end 14 of the conveyor will normally have been in the system the longest.) In other embodiments, a battery testing station may additionally or alternatively be provided at or near the battery delivery end 14 to test the batteries prior to installation. Whenever the computer 37 determines that the next battery to be installed within a vehicle is not sufficiently recharged, the computer can display a message on a road-side display sign (not shown) indicating that batteries are currently not available. This message also preferably indicates the number of minutes until recharged batteries will be available.

In some embodiments of the battery transfer station that have multiple conveyor loops or modules as illustrated in FIGS. 10 and 11, the battery elevator 43A at the receiving end may receive displaced batteries from vehicles that pass through the system, and selectively deliver the discharged batteries (under the control of the computer 37) to either the upper or the lower conveyor loop C1, C2. The elevator 43B at the battery delivery end can similarly be programmably shifted between the two conveyor levels to selectively remove batteries from the conveyor loops for delivery into vehicles. In one embodiment, the computer 37 is programmed to alternate between the two conveyor loops so that roughly half of the batteries are passed through the lower loop C1 and the other half passed through the upper loop C2. With this general approach, the addition of new conveyor loops can inherently increases the amount of time each battery spends in the system, and thus increase the available recharge time per battery. Additional conveyor loops can also be added to accommodate increased demand.

Although described in terms of several preferred embodiments, other embodiments that are apparent to those of ordinary skill in the art in view of the disclosure herein are also within the scope of this invention. Accordingly, the scope of this invention is intended to be limited only by reference to the appended claims.

What is claimed is:

1. A battery management system, comprising:
a battery control system;
a battery transfer station; and
an electric vehicle with a system for powering the vehicle, comprising a battery array with at least two individual batteries and an electric motor;
wherein the battery control system comprises an element to communicate with the battery transfer station.

2. The battery management system as in claim 1, wherein the communication element is wireless.

3. The battery management system as in claim 2, wherein the wireless communication element is a radio frequency transceiver which communicates bi-directionally.

4. The battery management system as in claim 1, wherein the communication element is wired.

5. The battery management system as in claim 1, wherein the battery array comprises a single row of batteries arranged in a relatively long and broad, but flat form, which can be laterally installed in the vehicle from one side of the vehicle.

6. The battery management system as in claim 1, wherein the communication element transmits the charge levels of each battery.

7. The battery management system as in claim 1, wherein the communication element transmits payment information.

8. The battery management system as in claim 1, wherein the communication element transmits the performance history of the individual batteries.

9. The battery management system as in claim 1, wherein the communication element transmits the type of battery of the individual batteries used in the vehicle.

10. The battery management system as in claim 1, wherein the battery control system monitors the battery charge levels and directs the energy stored by the battery array to the electric motor.

11. The battery management system as in claim 10, wherein the battery control system selects which battery to use.

12. The battery management system as in claim 10, wherein the battery control system provides an alert when battery power runs low.

13. The battery management system as in claim 10, wherein the battery control system updates a status gauge that can be monitored by a driver.

14. The battery management system as in claim 1, the battery transfer station comprising:
a drive through vehicle bay;
a continuous battery transfer conveyor within the transfer station, the conveyor having a battery receiving end which receives an at least partially discharged battery from a first end of the battery compartment, and having a battery delivery end which delivers a charged battery to a second end of the battery compartment, the conveyor having multiple battery positions between the receiving and delivery ends to hold multiple batteries;
a computer which controls the battery transfer conveyor by positioning the electric vehicle so that the battery receiving and delivery ends are adjacent the individual discharged batteries and then advancing the conveyor in single-battery-position increments to move batteries from the battery receiving end to the battery delivery end; and
a communication element to transmit and receive information with the battery control system.

15. The battery management system as in claim 14, wherein a driver of a vehicle may provide manual instructions to the battery transfer station to replace a battery which is not fully depleted.

16. The battery management system as in claim 14, the battery transfer station further comprising an electronic payment system wherein an operator of the vehicle can manually enter payment source information for payment of a fee associated with an exchange of the discharged battery with the charged battery.

17. A method of rapidly exchanging a battery of an electrically powered vehicle, the vehicle having at least two batteries within a compartment which extends through at least a portion of the vehicle, the method comprising the steps of:
providing a battery transfer station comprising:
a drive through vehicle bay;
a continuous battery transfer conveyor within the transfer station, the conveyor having a battery receiving end which receives an at least partially discharged battery from a first end of the battery compartment, and having a battery delivery end which delivers a charged battery to a second end of the battery compartment, the conveyor having multiple battery positions between the receiving and delivery ends to hold multiple batteries;
a computer which controls the battery transfer conveyor by positioning the battery delivery end adjacent the individual discharged battery and then advancing the conveyor in single-battery-position increments to move batteries from the battery receiving end to the battery delivery end; and
a communication element to transmit and receive information with a battery control system;
communicating wirelessly or wired with the battery transfer system to receive the history and current charge level information for each separate battery;
positioning the vehicle within the battery transfer station such that the first discharged battery is aligned with the battery receiving and delivery ends of the conveyor;
receiving payment source information via a payment system to enable the computer to initiate a battery exchange operation;
exchanging a first discharged battery with a first charged battery by programmably advancing the conveyor with the computer to shift the first charged battery from the delivery end of the conveyor into the compartment and moving the first discharged battery from the compartment to the receiving end of the conveyor.

18. The method as in claim 17, further comprising the steps of:
adjusting the position of the vehicle within the battery transfer station such that a next discharged battery is aligned with the battery receiving and delivery ends of the conveyor; and
exchanging the next discharged battery with a next charged battery by programmably advancing the conveyor with the computer to shift the next charged battery from the delivery end of the conveyor into the compartment and moving the next discharged battery from the compartment to the receiving end of the conveyor.

19. The method as in claim 17, wherein exchanging the discharged battery with the charged battery comprises advancing the conveyor by exactly one battery position.

20. The method as in claim 17, wherein exchanging the discharged battery with the charged battery comprises forcibly displacing the discharged battery from the battery compartment with the charged battery.

21. The method as in claim 17, wherein receiving payment source information comprises reading a credit card with a magnetic card reader.

22. The method as in claim 17, wherein receiving payment source information comprises the battery transfer station communicating with the battery control system to receive payment information.

23. The method as in claim 17, wherein the conveyor comprises battery charging stations on at least some of the battery positions, and wherein the method further comprises charging the discharged battery at successive charging stations.

24. The method as in claim 17, further comprising the steps of:
providing at least one battery expansion module coupled to the continuous conveyor by a battery elevator, the expansion module including a second battery conveyor which holds multiple batteries; and
advancing the discharged battery to the expansion module with the elevator.

25. The method as in claim 17, further comprising advancing the vehicle through the battery transfer station above or below a vertically displaced segment of the conveyor without interrupting a battery transfer path between the receiving and delivery ends of the conveyor.

26. The method as in claim 17, wherein the conveyor comprises an electronic sensing device coupled to the computer for detecting unique ID codes of batteries on the conveyor, and wherein the method further comprises sensing the unique ID code of the discharged battery with the sensing device.

27. The method as in claim 26, wherein the electronic sensing device comprises a bar code reader.

28. The method as in claim 26, further comprising the steps of:
accessing a database with the unique ID code and the computer to retrieve historical data which is unique to the discharged battery; and
using the historical data to determine whether to remove the discharged battery from conveyor.

29. The method as in claim 28, wherein the historical data indicates a date of first use of the discharged battery.

30. The method as in claim 28, wherein accessing a database comprises accessing a centralized database over a computer network, the centralized database located at a geographically remote location relative to the battery transfer station.

31. The method as in claim 28, wherein the historical data indicates the number of times the discharged battery has previously been recharged.
